(19) United States
(12) Patent Application Publication
(10) Pub. No.: US 2013/0064752 A1
(43) Pub. Date: Mar. 14, 2013

(54) METHOD FOR FIXING CARBON DIOXIDE

(71) Applicants: Tae Young KIM, Suwon (KR); Sung Yeup CHUNG, Seoul (KR); Ki Chun LEE, Seoul (KR); Min Ho CHO, Seongnam (KR); Seok Gyu SONH, Suwon (KR); Dong Cheol PARK, Incheon (KR)

(72) Inventors: Tae Young KIM, Suwon (KR); Sung Yeup CHUNG, Seoul (KR); Ki Chun LEE, Seoul (KR); Min Ho CHO, Seongnam (KR); Seok Gyu SONH, Suwon (KR); Dong Cheol PARK, Incheon (KR)

(73) Assignees: HYUNDAI MOTOR COMPANY, Seoul (KR); HYUNDAI STEEL COMPANY, Incheon (KR); KIA MOTORS CORPORATION, Seoul (KR)

(21) Appl. No.: 13/311,401

(22) Filed: Dec. 5, 2011

(30) Foreign Application Priority Data
Sep. 14, 2011 (KR) 10-2011-0092495

(51) Int. Cl. C01D 7/00

(52) U.S. Cl. 423/429; 423/421

(57) ABSTRACT

The present invention provides a method for carbon dioxide fixation, which comprises extracting an alkali metal component from a raw slag in a first reactor by using an ammonium salt solvent to produce a solution containing the extracted alkali metal component and then reacting the solution with carbon dioxide in a second reactor to produce a carbonate precipitate. With this method, an alkali metal component can be extracted and a carbonate precipitate can be obtained in a simpler and cost-effective manner, among others.

### CROSS-REFERENCE TO RELATED APPLICATION

This application claims the benefit of Korean Patent Application No. 10-2011-0092495 filed Sep. 14, 2011, under 35 U.S.C. §119(a). The entire content of the aforementioned application is incorporated herein by reference.

### BACKGROUND

(a) Technical Field

The present invention relates to a method for fixing carbon dioxide contained in an exhaust gas. More particularly, it relates to a method for fixing carbon dioxide by extracting an alkali metal component from a raw slag and reacting the extracted alkali metal component with carbon dioxide to produce a carbonate precipitate of the alkali metal.

(b) Background Art

Exhaust gases including carbon dioxide in many fields of industry are required to be treated for environmental consideration. A typical process of treating an exhaust gas includes a separation/recovery process and a fixation (immobilization) process

The fixation process aims to convert carbon dioxide to a carbon-containing compound (e.g., carbonate) and convert the carbon-containing compound to a compound that is applicable to other industrial processes, thereby being able to remove carbon dioxide, which is known to cause global warming, in an environmental-friendly way and utilize carbon dioxide as a useful material.

To date, a single reactor in which alkali metal component extraction from a raw slag is performed concurrently with carbonation reaction has been used. However, in this conventional method, because the alkali metal component extraction and the carbonation reaction are performed concurrently, an extracted alkali metal component is carbonated, the carbonated component is formed as a precipitate, and the carbonate precipitate is then accumulated on the surface of the slag, which causes the alkali metal component extraction to be hindered, the carbonation reaction to take longer time, and the carbonation rate to be decreased.

Further, in the conventional method, because the slag, carbonate precipitate, and residual process water/solution co-exist, it is difficult to reuse process water/solution and a chemical solvent (e.g., acetic acid) used for extraction.

Particularly, in case where acetic acid is used to extract an alkali metal component such as calcium (Ca), magnesium, and the like from a raw steel slag or natural mineral, a large amount of acetic acid is required, which causes processing costs to be increased. Further, a large amount of NaOH is required as a pH adjuster for carbonation reaction, which also causes processing costs to be increased.

Moreover, in some cases, the use of NaOH causes overproduction of suspended solids (e.g., Ca(OH)₂), thereby preventing alkali metal component (e.g., Ca) from being converted to a carbonate (e.g., CaCO₃).

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

A method for fixing carbon dioxide contained in an exhaust gas is provided. In an embodiment, the method comprises the steps of: extracting an alkali metal component from a raw slag in a first reactor by using an ammonium salt solvent to produce a solution containing the extracted alkali metal component; and reacting the solution with carbon dioxide in a second reactor to produce a carbonate precipitate.

The ammonium salt may, preferably, be any one selected from the group consisting of ammonium chloride, ammonium nitrate and ammonium acetate.

The ammonium salt may, preferably, have a pH value of about 6 and the solution containing the extracted alkali metal component produced after the extraction may, preferably, have a pH value of about 8˜9 without performing a separate pH adjustment step.

Suitably, after the carbonate precipitate is produced, the solution may have a pH value of about 6˜7.

Suitably, after the carbonate precipitate is produced, at least a portion of the solution may be recirculated to the first reactor for reuse.

In another embodiment, the method may further comprise, before reacting the solution with carbon dioxide, a step of adding a pH adjuster to raise the pH of the solution. The pH adjuster may be NaOH and the pH of the solution may be raised to about 12

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a flow chart representing a carbon dioxide fixation method according to a first embodiment of the present invention; and

FIG. 2 is a flow chart representing a carbon dioxide fixation method according to a second embodiment of the present invention.

Reference numerals set forth in the Drawings includes reference to the following elements as further discussed below:

10: alkali metal component extraction reactor

20: carbonation reactor

30: carbon dioxide supplier

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

### First Embodiment

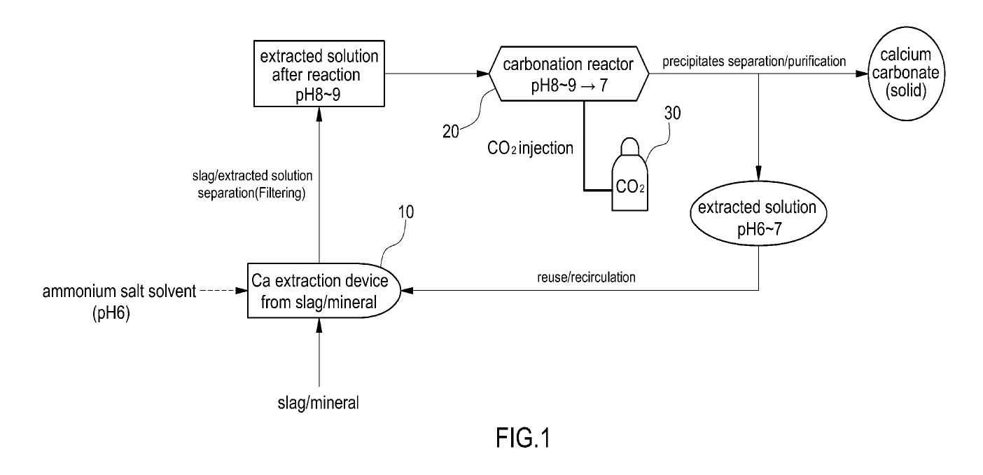

As shown in FIG. 1, an alkali metal component (e.g., Ca, Mg, etc.) is extracted at an alkali metal component extraction reactor (10). In more detail, a raw slag (e.g., a slag from a blast furnace iron making process, a slag from an electric furnace steel making process, etc.) is supplied to the alkali metal component extraction reactor (10). An ammonium salt solvent is supplied as an extraction solvent. The resulting solution is stirred until at least 90% of the alkali metal component contained in the raw slag is extracted.

Examples of the extraction solvent may include, but not limited to, ammonium chloride, ammonium nitrate, and ammonium acetate. The pH of the extraction solvent itself is about 6 and the pH of the post-extraction solution is about 8˜9. Thus, without having to adjust the pH of the post-extraction solution, the extracted alkali metal contained in the post-extraction solution can be easily converted to a carbonate through carbonation reaction at a room temperature and atmospheric pressure in a carbonation reactor (20).

The post-extraction solution exited from the alkali metal component extraction reactor (10) is supplied to the carbonation reactor (20). Carbon dioxide is supplied to the carbonation reactor (20) from a carbon dioxide supplier (30). The amount of supplied carbon dioxide is controlled according to a ratio of concentration of the alkali metal component of the solution introduced into the carbonation reactor (20). An air diffuser (not shown) may be provided in the carbonation reactor (20) to receive carbon dioxide supplied from the carbon dioxide supplier (30) and generate carbon dioxide bubbles.

In the carbonation reactor (20), a carbonation reaction is performed and a carbonate precipitate is produced. Namely, gaseous carbon dioxide is reacted with an alkali metal ion at about pH 8˜9 in the carbonation reactor (20) to produce a carbonate precipitate. The carbonate precipitate is separated from the solution contained in the carbonation reactor (20) by a solid/liquid separation process.

The solution separated by a solid/liquid separation process has a pH value of about 6˜7. At least a portion of the solution is recirculated to the alkali metal component extraction reactor (10) for reuse.

### Second Embodiment

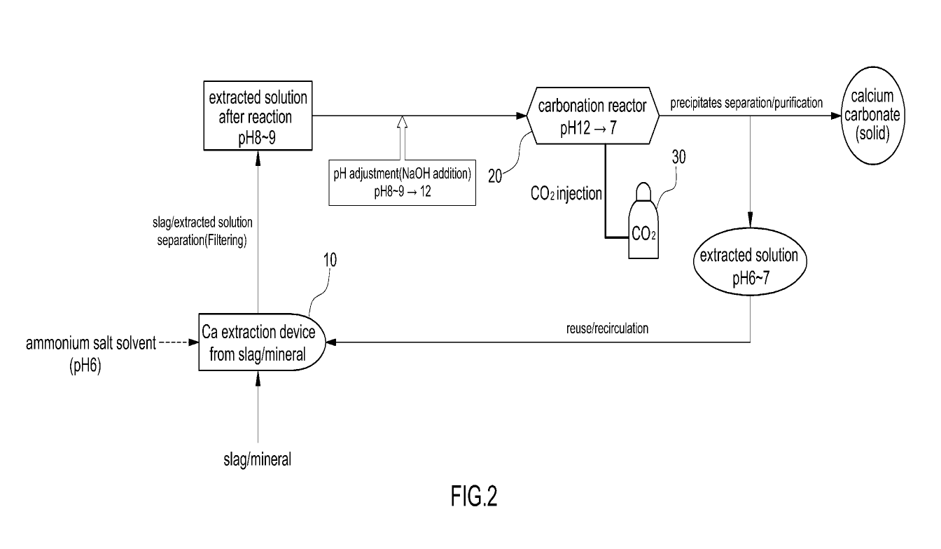

As shown in FIG. 2, an alkali metal component (e.g., Ca, Mg, etc.) is extracted at an alkali metal component extraction reactor (10). In more detail, a raw slag (e.g., a slag from a blast furnace iron making process, a slag from an electric furnace steel making process, etc.) is supplied to the alkali metal component extraction reactor (10). An ammonium salt solvent is supplied as an extraction solvent. The resulting solution is stirred until at least 90% of the alkali metal component contained in the raw slag is extracted.

Examples of the extraction solvent may include, but not limited to, ammonium chloride, ammonium nitrate, and ammonium acetate. The pH of the extraction solvent itself is about 6 and the pH of the post-extraction solution is about 8˜9. In this embodiment, the pH of the post-extraction solution is adjusted to about 12 before the post-extract solution is introduced into a carbonation reactor (20). For example, a pH adjuster (e.g., NaOH) may, suitably, be added to the post-extraction solution. With this pH adjustment, the amount of a carbonate precipitate after the carbonation reaction in the carbonation reactor becomes greater.

The post-extraction solution exited from the alkali metal component extraction reactor (10) is, after the pH adjustment, supplied to the carbonation reactor (20). Carbon dioxide is supplied to the carbonation reactor (20) from a carbon dioxide supplier (30). The amount of supplied carbon dioxide is controlled according to a ratio of concentration of the amount of the alkali metal component of the solution introduced into the carbonation reactor (20). An air diffuser (not shown) may be provided in the carbonation reactor (20) to receive carbon dioxide supplied from the carbon dioxide supplier (30) and generate carbon dioxide bubbles.

In the carbonation reactor (20), a carbonation reaction is performed and a carbonate precipitate is produced. Namely, gaseous carbon dioxide is reacted with an alkali metal ion at about pH 8˜9 in the carbonation reactor (20) to produce a carbonate precipitate. The carbonate precipitate is separated from the solution contained in the carbonation reactor (20) by a solid/liquid separation process. Thereafter, the pH of dissolved carbonate is adjusted to be 7 or higher, thereby obtaining a high purity of carbonate.

The solution separated by a solid/liquid separation process has a pH value of about 6˜7. At least a portion of the solution is recirculated to the alkali metal component extraction reactor (10) for reuse.

According to the present invention, by using an ammonium salt solvent, carbonation reaction can be performed in a highly selective and efficient manner, at a lower cost, and in a milder condition (room temperature and atmospheric pressure). By using an ammonium salt solvent instead of acetic acid solvent, a step of pH adjustment can be eliminated, which thereby simplifies the process step and reducing overall process cost. Further, by adjusting the pH of the post-extraction solution before introducing the post-extraction solution into a carbonation reactor, the amount of a carbonate precipitate after the carbonation reaction in the carbonation reactor becomes greater. In addition, since the solution exited from the carbonation reactor has an appropriate pH value that can be reused in the extraction reactor, thereby reducing overall process cost. Moreover, since no or less suspended solids, a by-product that can be produced when a large quantity of a pH adjuster (e.g., NaOH) is used, are produced, a highly pure carbonate (e.g., CaCO₃) can be obtained in a simpler and cheaper way.

What is claimed is:

1. A method for fixing carbon dioxide, the method comprising:
(a) extracting an alkali metal component from a raw slag in a first reactor by using an ammonium salt solvent to produce a solution containing the extracted alkali metal component; and
(b) reacting the produced solution with carbon dioxide in a second reactor to produce a carbonate precipitate.

2. The method of claim 1, wherein the ammonium salt is any one selected from the group consisting of ammonium chloride, ammonium nitrate and ammonium acetate.

3. The method of claim 1, wherein the ammonium salt has a pH value of about 6, and
wherein the solution containing the extracted alkali metal component produced after the extraction has a pH value of about 8˜9 without performing a separate pH adjustment step.

4. The method of claim 1, further comprising, before the step (b), a step of adding a pH adjuster to raise the pH of the solution.

5. The method of claim 4, wherein the pH adjuster is NaOH and the pH of the solution is raised to about 12

6. The method of claim 1, wherein the solution, after the carbonate precipitate is produced, has a pH value of about 6˜7.

7. The method of claim 1, wherein after the carbonate precipitate is produced, at least a portion of the solution is recirculated to the first reactor for reuse.
